(19) United States
(12) Patent Application Publication
(10) Pub. No.: US 2018/0317523 A1
(43) Pub. Date: Nov. 8, 2018

(54) NANOPARTICLES, NANOEMULSIONS AND THEIR FORMATION WITH MIXING CHAMBER MICRONIZATION

(71) Applicant: BASF SE, Ludwigshafen am Rhein (DE)

(72) Inventors: THRANDUR HELGASON, Mannheim (DE); ANJA WEILAND, Maxdorf (DE); HERIBERT BOHN, Wattenheim (DE)

(21) Appl. No.: 15/568,287

(22) PCT Filed: Apr. 20, 2016
(86) PCT No.: PCT/EP2016/058684

§ 371 Date: Oct. 20, 2017

(30) Foreign Application Priority Data
Apr. 22, 2015 (EP) 15164587.6

(51) Int. Cl. A23L 2/52; A23L 33/155; A23L 29/10; A23L 33/12; A23P 10/40; A23L 33/11

(52) U.S. Cl. CPC A23L 2/52; A23L 33/155; A23L 29/10; A23V 2002/00; A23P 10/40; A23L 33/11; A23L 33/12

(57) ABSTRACT

The instant invention concerns aqueous clear, transparent dispersions of lipid-soluble bioactive materials having particle sizes of 20-180 nm or 20-100 nm, processes for their preparation, their use, especially as or in beverages, solid particles derived therefrom, a process/method to evaluate the applicability of emulsifiers for the preparation of such dispersions.

Any of the documents cited herein are incorporated by reference in their entirety.

The instant invention concerns clear, transparent dispersions of lipid-soluble bioactive materials having particle sizes of about 20-180 nm or about 20-100 nm, processes for their preparation, their use, especially as or in beverages, solid particles derived therefrom, a process/method to evaluate the applicability of emulsifiers for the preparation of such dispersions.

### BACKGROUND OF THE INVENTION

Functional foods is a fast growing market where bioactive materials (or in other words bioactive compounds) are intentionally added to the food to improve the consumer's health, well-being or comfort. Furthermore, beverages are convenient products for consumers and a very popular form of functional foods. However, most bioactive materials are hydrophobic which tend to phase separate in the beverage and increase turbidity, i.e., the beverage becomes kind of “milky”, which is unpleasant to the consumer's eye, suggesting, wrongly, that the beverage has gone bad. There is, therefore, a need to deliver high amounts of bioactive material without impacting the appearance of the beverage. Normally, this is done by making emulsions (liquid hydrophobic droplets in a continuous water phase) or suspensions (solid hydrophobic particles in a continuous water phase). These structures are then stabilised by surfactants or emulsifiers. However, the problem is that these structures are so large that they scatter light unevenly and thus make the product look turbid. There is therefore an increasing demand for clear dispersions, particularly beverages. However, if lipid-soluble (i.e. oil-soluble) bioactive ingredients are used one needs to form very small particles or emulsions to prevent turbid appearance. This turbid appearance comes when light is scattered on the surface of particles or emulsion droplets. This occurs because the refractive index of the continuous phase and the dispersed phase is different. However, there is one way to prevent scattering, which is to make the particles much smaller than the wavelength of visible light. These small particles still scatter light but they scatter light evenly in all direction thus, making them effectively invisible—however it is not trivial to make such dispersions which are stable. Furthermore, in the prior art such dispersions are prepared by making microemulsions which are thermodynamically stable systems which are made by making surfactants and hydrophobic material self-assemble into very small micelles (<100 nm) with very narrow size range. The problem with microemulsions (like those of WO 99/11240 A1), however, is that large amounts of surfactants are needed and a lot of these surfactants are not allowed in food products, have negative impact on taste and/or cause foaming in the beverage. Furthermore, such microemulsions are thermodynamically stable systems and as such are very sensitive to changes in conditions such as dilution, temperature and changes in the recipe.

From US 2010/0112073 A1 it is known to prepare nanoparticles of non-polar compounds by entrapping and bonding those to an intermediate surfactant layer and surrounding them with an at least partially crosslinked outer polymeric protective layer.

From US 2008/0207775 A1 it is known to prepare carotenoid suspensions with only water as solvent and in which the small particle sizes are achieved by comminution. Turbidities are not discussed.

From US 2013/0116261 A1 it is known to prepare specific nanoparticles in which admixture with water is done by simple mixing. Turbidities are not discussed.

From EP 0 065 193 A2 it is known to prepare carotenoid and retenoid in colloidaly disperse form by solving the active ingredient with an organic solvent at temperatures above 50° C. and the use of specific swellable colloid emulsifiers. Turbidities are not discussed.

Accordingly, there is still a demand to provide stable small particle dispersions that are transparent and are not thermodynamically stabilised (i.e. that are kinetically stable), which can be easily prepared and which can be used as or in beverages.

### OBJECTS OF THE INVENTION

It was an object of the instant invention to provide aqueous stable and clear, transparent dispersions of oil-soluble bioactive materials as well as to provide an effective process for their preparation.

Another object of the instant invention was to provide as clear as possible, ideally completely clear (NTU-values below 20) beverages consisting of or containing the dispersions as well as to provide solid particles made from the dispersion as well as a process for their preparation.

It was an object of the invention that the dispersions should be kinetically stable, they should not be based on microemulsions and the emulsifiers should preferably be natural ones.

### SUMMARY OF THE INVENTION

The object of the instant invention has been solved by the dispersions of the present invention and the process for preparation of dispersions according to the invention as well as respective particles and their preparations and the uses of the products.

Definitions and Clarifications of Terms:

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a”, “an” and “the” include plural referents unless otherwise specified.

As used herein, the term “about” when combined with a value refers to plus and minus 10% of the reference value unless otherwise specified. For example, a temperature of about 50° C. refers to a temperature of 50° C.±5° C., etc.

Any indications of quantity given in the instant invention are to be considered as indications of quantity by weight, for instance also w/w% values, if not specified otherwise.

In the instant invention the term “room temperature” is intended to mean a temperature of 20° C.; if not specified otherwise, temperature values are to be considered as degrees centigrade (° C.).

In the instant invention are the given reactions or process steps are carried out at normal pressure/atmospheric pressure, that is at 1013 mbar.

In the instant invention the term “and/or” includes any and all combinations of one or more of the associated listed items.

In the instant invention 1 ppm is 1 part per weight in 1 million parts per weight, unless otherwise stated.

According to the invention the particle sizes are measured by dynamic light scattering and preferably given as the z-average size, and can be measured with any dynamic light scattering device, for example a BI-90 (Brookhaven Instruments, Blue point Holtsville, N.Y., USA).

For the purpose of this invention the term “lipid-soluble” or “oil-soluble” means soluble in non-polar solvents such as chloroform, ether and oils, and having less than 1% w/w solubility in water at room temperature.

According to the present invention the turbidity is given as NTU which is nephelometric turbidity unit which is measured with any standard turbidimeter, in one embodiment of the invention and the examples, with a HACH 2100AN Turbidimeter.

For the purpose of this invention a transparent dispersion is defined either as an aqueous dispersion containing 5 ppm bioactive material, in particular carotenoid, with an NTU value below 20 or as an aqueous dispersion containing 100 ppm bioactive material, in particular CLA, phytosterol or omega-3 fatty acid, with an NTU value below 20.

That means that the term “non-turbid” within the instant invention means a turbidity value of below 20.

For the purpose of this invention the term “stable” in the context of the dispersions means no particle size increase and no gravitational separation (sedimentation or creaming) at room temperature during storage of the product for at least 6 to 12 months.

### DETAILED DESCRIPTION

A first subject of the instant invention are stable aqueous clear, transparent dispersions of oil-soluble bioactive compounds and at least one emulsifier, which are not microemulsions.

The particles containing the bioactive compound have particles size of from 20-180 nm. In a variation of the invention the particles have particle sizes of 20-100 nm.

The dispersions have an NTU-value of 1-180 at concentrations of 100 ppm of bioactive material and/or an NTU-value of 0.01-20 at concentrations of 5 ppm of bioactive material.

In these dispersions the bioactive compound can in general be any oil-soluble (lipid-soluble) bioactive material, but in one embodiment is selected from the group consisting of omega-3 fatty acids, carotenoids, vitamin-A, vitamin-D, phytosterols, CLA, animal oils and mixtures thereof.

In another embodiment,
(i) the bioactive is selected from the group consisting of carotenoid, particularly beta-carotene, oil containing omega-3 fatty acids, preferably animal oil, particularly fish oil, PUFA, particularly CLA and phytosterols and
(ii) the emulsifier is selected from the group selected from saponin, surface active protein, preferably selected from the group consisting of vegetable, protein, gelatine, whey protein, whey protein isolate, sodium caseinate and other milk proteins, soy protein, potato protein, potato protein isolate and mixtures thereof, phospholipides, preferably those with plant derived fatty acid residues, monosaccharide monoesters of fatty acids, preferably sucrose monopalmitate and mixtures thereof.

In yet another embodiment of the instant invention, the dispersions are prepared by
a) preparation of an organic phase by dissolving at least one bioactive material and optionally at least one antioxidant in an organic solvent that is water miscible, most preferably tetrahydrofurane,
b) preparation of a water phase by dissolving at least one emulsifier and optionally at least one antioxidant in distilled water,
c) combining the organic phase and the water phase in a ratio of from 1:10 to 1:30, preferably from 1:15 to 1:25, more preferably from 1:17 to 1:23, by a means to create highly turbulent flow, preferably by colliding a jet of each fluid in a T-intersection pipe with small diameter, preferably between 0.02 to 1.0 mm, most preferably 0.1 mm at high velocity, preferably between 100 and 10000 m/s for the water phase and between 5 and 100 m/s for the organic phase,
   more preferably between 500 and 2000 m/s for the water phase and between 25 and 75 m/s for the organic phase,
   most preferably 900 m/s for the water phase and 50 m/s for the organic phase,
d) recovering the resulting dispersion,
e) optionally removing the organic solvent from the dispersion.

In a variation of the instant invention, the velocities for both the water phase and the organic phase can be as high as possible, wherein the velocity of the water phase is faster than that of the organic phase, feasible example are at least twice as fast, at least three times as fast, at least four times as fast, at least five times as fast, at least six times as fast, at least seven times as fast, at least eight times as fast, at least nine times as fast, at least ten times as fast and so on.

In another variation of the instant invention the velocities of the water phase and the organic phase can be about the same.

As means for creating highly turbulent flow in principle any of the art-known means can be used.

In one embodiment of the instant invention a T-intersection pipe is used.

In some other embodiments when the bioactive is a carotenoid it can be employed together with an isomerisation aid, preferably MCT oil.

A second basic subject of the instant invention is a process for preparing stable, clear, transparent dispersions, especially those described above or further below, or particles wherein the process comprises the steps of
a) preparation of an organic phase by dissolving at least one bioactive material and optionally at least one antioxidant in an organic solvent that is water miscible, most preferably tetrahydrofurane,
b) preparation of a water phase by dissolving at least one emulsifier and optionally at least one antioxidant in distilled water,
c) combining the organic phase and the water phase in a ratio of from 1:10 to 1:30, preferably from 1:15 to 1:25, more preferably from 1:17 to 1:23, by a means to create highly turbulent flow, preferably by colliding a jet of each fluid in a T-intersection pipe with small diameter (0.1 mm) at high velocity (900 m/s for the water phase and 50 m/s for the organic phase),
d) recovering the resulting dispersion,
e) optionally removing the organic solvent from the dispersion.

In one embodiment of the instant invention, the fluids in step c) are combined in such a way that the final mixture contains between 1 and 1000 ppm, preferably between 50 and 200 ppm, most preferably 100 ppm of the respective bioactive material, between 1 and 1000 ppm, preferably between 25 and 100 ppm, most preferably 50 ppm of the respective emulsifier, 10 ppm dl-alpha-tocopherol, 200 ppm sodium ascorbate, and 5% of the organic solvent.

In a further subject of the instant invention, a process for preparing solid particles from dispersions prepared as outlined above, the dispersions are dried resulting in dry powder with water content below 10% by weight, preferably below 5% by weight, using for example spray drying, to give the particles.

A fourth basic subject of the instant invention is the use of the dispersions according to the instant invention or of dispersions prepared according the instant invention's preparation process as or in beverages.

Accordingly, a fifth basic subject of the instant invention are preparations, especially beverages, comprising or consisting of a dispersion according to the instant invention or of dispersions prepared according to the instant invention's preparation process.

Not the least, a subject of the instant invention are solid particles prepared by the above described process.

The instant invention's approach was to develop a system that can make clear dispersion, especially beverages, in a simple and repeatable way, using various bioactive materials and emulsifiers.

In the instant invention's process, turbidity was measured at 5 ppm and 100 ppm concentration of the bioactive material in the dispersion, along with the particle size of the dispersed material.

The water miscible organic solvent of the instant can in essence be any water miscible solvent, which preferably are miscible with water in an amount of 10% by weight, show a boiling point below 200° C. and/or have less than ten carbon atoms.

The water miscible organic solvent in one embodiment of the instant invention is selected from the group consisting of alcohols, ethers, esters, ketones, acetales and mixtures thereof. In yet another embodiment of the instant invention the water miscible solvent is selected from the group consisting ethanol, n-propanol, i-propanol, 1,2-butanedioel-1-methylether, 1,2-propanediole-1-n-propylether, acetone, tetrahydrofurane and mixtures thereof.

The most preferred water miscible organic solvent is tetrahydrofurane.

In one embodiment the dispersion of the present invention is a stable, transparent aqueous transparent dispersion comprising at least one dispersed carotenoid, particularly beta-carotene, in a concentration of from 1-150 ppm, preferably 4-120 ppm. In one embodiment the concentration of the dispersed carotenoid, particularly beta-carotene, is from 90-110 ppm, in particular 100 ppm. In another embodiment the concentration of the dispersed carotenoid, particularly beta-carotene, is from 3-7 ppm, in particular 5 ppm.

In one embodiment the dispersion of the present invention is a stable, transparent aqueous transparent dispersion comprising at least one dispersed oil containing omega-3 fatty acids, preferably animal oil, particularly fish oil, in a concentration of from 1-150 ppm, preferably 4-120 ppm. In one embodiment the concentration of the dispersed oil containing omega-3 fatty acids, preferably animal oil, particularly fish oil, is from 90-110 ppm, in particular 100 ppm. In another embodiment the concentration of the dispersed oil containing omega-3 fatty acids, preferably animal oil, particularly fish oil, is from 3-7 ppm, in particular 5 ppm.

In one embodiment the dispersion of the present invention is a stable, transparent aqueous transparent dispersion comprising at least one dispersed polyunsaturated fatty acid (PUFA), particularly conjugated linoleic acid (CLA), in a concentration of from 1-150 ppm, preferably 4-120 ppm. In one embodiment the concentration of the dispersed polyunsaturated fatty acid (PUFA), particularly conjugated linoleic acid (CLA), is from 90-110 ppm, in particular 100 ppm. In another embodiment the concentration of the dispersed polyunsaturated fatty acid (PUFA), particularly conjugated linoleic acid (CLA), is from 3-7 ppm, in particular 5 ppm.

In one embodiment the dispersion of the present invention is a stable, transparent aqueous transparent dispersion comprising at least one dispersed plant steroid, particularly phytosterole, in a concentration of from 1-150 ppm, preferably 4-120 ppm. In one embodiment the concentration of the dispersed plant steroid, particularly phytosterole, is from 90-110 ppm, in particular 100 ppm. In another embodiment the concentration of the dispersed plant steroid, particularly phytosterole, is from 3-7 ppm, in particular 5 ppm.

In the context of the instant invention, inter alia, in particular the following major surprising advantageous effects were found:

It was possible to prepare nanoparticles and nanodispersions for all the bioactive materials with potato proteins as emulsifiers.

It was possible to prepare transparent, non-turbid dispersions containing high concentrations (at least up to 100 ppm) of bioactive material without making microemulsions. The advantage of the instant invention in this context is that microemulsions require very high concentration of surfactants that could create foam in the end application and the surfactants used have low consumer acceptance, whereas this problem does not arise with the instant invention.

In one alternative of the invention the carotenoid is selected from the group consisting of: beta-carotene, cantaxanthin, astaxanthin, lutein, zeaxanthin, beta-zeacaroten, lycopene, apocarotenal, bixin, paprika olioresin, capsanthin and capsorubin and mixtures thereof.

All carotenoids can be natural or nature identical. Nature identical carotene is a synthetic carotene which has exactly the same chemical structure as natural carotene found in nature.

In one particularly preferred alternative of the invention the carotenoid is beta-carotene.

In one alternative of the invention the oil containing omega-3 fatty acids is selected from the group consisting of fish oil, algea oil vegetable oil and mixtures thereof.

In one particularly preferred alternative of the invention the animal oil is fish oil.

In one preferred alternative of the invention the PUFA is CLA.

In one alternative of the invention the plant steroid is selected from the group consisting of phytosterol, phytosterols esterified with fatty acids and mixtures thereof. Examples of specific compounds of some embodiments of the invention are: beta-sistosterol, campesterol, stigmasteroil.

In one particularly preferred alternative of the invention the plant steroid is phytosterol.

In the instant invention the employed emulsifiers are natural occurring or natural-identical emulsifiers. If the preparation of the instant invention is to be used as or in food stuff or beverages, the employed emulsifier(s) ought to be food-approved.

In one alternative of the instant invention the emulsifier is selected from the group of
a) amphiphatic glycosides, preferably saponine,
b) surface active protein, preferably selected from the group consisting of whey protein, whey protein isolate, sodium caseinate and other milk proteins, soy protein, potato protein, potato protein isolate and mixtures thereof
c) phospholipides, preferably those with plant derived fatty acid residues,
d) monosaccharide monoesters of fatty acids,
and mixtures thereof.

Particularly preferred emulsifiers of one embodiment of the instant invention are:
a) saponine,
b) potato protein and/or potato protein isolate,
c) rapeseed lecithin,
d) sucrose monopalmitate.

In one embodiment of the instant invention, an example for a) is Q-Naturale 200, an example for b) is Solanic 306 P, an example for c) is Lecithin RAP 200 and an example for d) is Habo Monoester.

Additionally in the instant invention it is possible to add additives to the process/dispersion, in particular anti-oxidants and/or, in the case of the bioactive material being a carotenoid, oil.

Useable anti-oxidants for use in the organic phase are oil-soluble ones and are for example selected from the group consisting of d,l-alpha-tocopherole, ethoxyquin, hindered phenolic antioxidants, such as t-butylhydroxytoluol, t-butylhydroxyaniso, t-butylhydroxyquinone, vitamin A, retinoic acid and its esters with C₁-C₂₀ carbon chain length, vitamin D2 and D3, alpha, beta, gamma, and delta tocopherols or mixtures comprising at least two of the tocoperols, alpha, beta, gamma, and delta tocotrienols or mixtures comprising at least two of the tocotrienols, natural extracts comprising at least one of the above compounds, phenolic diterpenes such as carnosol, carnosic acid, derivatives of cinnamic acid like 2-ethoxyethyl p-methoxycinnamate, ethylhexyl p-methoxycinnamate, 2-ethylhexyl 4-methoxycinnamate, methyl diisopropylcinnamate, isoamyl 4-methoxycinnamate, diethanolamin 4-methoxycinnamate, their respective derivatives and mixtures thereof.

Commercially available examples for some oil-soluble anti-oxidants are BASF products Tinogard TT, Tinogard HS, LC-gallates, Eugenol, Thymol, Organosolv-Lignin.

In one embodiment of the instant invention the oil-soluble anti-oxidant is d,l-alpha-tocopherole.

Useable water-soluble anti-oxidants for use in the water phase are for example selected from the group consisting of natural compounds that are active as antioxidants because they comprise a phenolic OH-group in their chemical structure: like hydroxy derivatives of cinnamic acid, e.g. hydroxycinnamic acids, hydroxycinnamates, which are a class of polyphenols having a C₆-C₃ skeleton, for example hydroxyhydrocinnamate, caffeic acid, ferulic acid, tyrosol, hydroxytyrosol, cinnamic acid, chlorogenic acid, coumarin, coumarinic acid, sinapic acid, cinnamic acid, chicoric acid, and esters of any of these compounds with C₁-C₂₀, extracts of plants rich in at least one of the above compounds, rosmarinic acid, hydroxytyrosol, extracts from common spices. In one embodiment common spices are selected from the group comprising rosemary, lemon balm, oregano, thyme, peppermint, sage or similar plants comprising or being rich in at least one of the above compounds, flavons, which are a class of natural compounds of which more than 5000 exist, used as antioxidants can be any of them as extracted from plants such as tea or any other plant that comprise or is rich in catechin or epicatechin or derivatives, whereby these compounds can be glycosylated with carbohydrates or esterified with fatty acids C₁-C₂₀ or gallic acid;extracts from plants such as tea, olives, pears, apples comprising or being rich in one or more of the above mentioned compounds, sodium ascorbate, polyphenole, Teanova 80, glutathione, lipoic acid, catechin, punicalagin, xanthone, benzotropolones, preferably sodium ascorbate, and mixtures thereof.

In one embodiment of the instant invention the water-soluble anti-oxidant is ascorbic acid and/or sodium ascorbate.

In one embodiment of the present invention, in which the bioactive material is a carotenoid, the carotenoid can be melted and/or solved and/or isomerised from trans to cis in triacylglycerol oil, such as MCT oil (medium-chain triacylglycerol), olive oil, corn oil, sunflower oil, peanut oil, soy oil or other alternative vegetable oil, preferably MCT oil.

Accordingly in case of the bioactive material being a carotenoid, the carotenoid-emulsion of the invention comprises in one embodiment triacylglycerol oil, selected from the group consisting of MCT oil (medium-chain triacylglycerol), olive oil, sunflower oil, peanut oil, soy oil and vegetable oil, preferably MCT oil, in a weight amount of up to 10 parts of oil per 1 part of carotene, preferably 1 to 4 parts of oil per 1 part of carotene.

The triacylglycerol oil used in the present invention is in one embodiment an ester of glycerol where glycerol is esterified to a fatty acid where the fatty acid can have 4-22 carbon chain length and double bond on any of the carbon positions.

Preferably MCT oil is used, where the MCT is an ester of glycerol where glycerol is esterified to a fatty acid where the fatty acid are saturated and have 6-10 carbon chain length, preferably 8-10 carbon chain length.

The isomerisation can be carried out in the presence of an oil soluble antioxidant.

Useably co-emulsifiers, in particular for use with rapeseed lecithin, are sugar esters and/or the above mentioned emulsifiers.

In one embodiment, as bioactive materials those selected from the group consisting of omega-3 fatty acids, carotenoids, vitamin-A, vitamin-D, phytosterol, CLA and mixtures thereof can be employed in the context of the instant invention.

In one embodiment of the invention the dispersions and/or particles of the invention are used as colorant, preferably natural or naturally identical colorant. The the dispersions and/or particles of the invention can be used as colorant in beverages like soft drinks, flavoured water, fruit juices, punches or concentrated forms of these beverages but also alcoholic beverages and instant beverage powders.

The dispersions of the instant invention can be used as beverages themselves. In this embodiment further additives usually employed in beverages like flavours, colorants, stabilisers etc. can be added.

In a further embodiment the dispersions and/or particles of the invention are used in food and/or feed. The dispersions and/or particles of the invention can be used in ice cream, cheese, milk product like milk drinks or yoghurt, soy milk and the like, confectionary products, gums, dessert, candies, puddings, jellies, instant pudding powder, but also in snacks, cookies, sauces, cereals, salad dressing, soups.

The dispersions and/or particles of the invention can also be used in pharmaceutical preparations, such as tablets or capsules, or cosmetic and dermal products.

One decisive advantage of the instant invention is that the method will always give stable transparent dispersions without long development as long as the employed emulsifier is capable.

A further advantage of the instant invention is the fact that it is possible to use proteins as emulsifiers/stabilisers, which is not possible in microemulsion-processes.

Particularly preferred embodiments of the instant invention are dispersions and/or nanoparticles, prepared according to the process of the instant invention, in which the bioactive material and the emulsifiers are respectively combined as follows; each of the following is a specific embodiment of the instant invention:
beta-carotene with quillaja emulsifier (saponin),
beta-carotene with potato protein isolate,
beta-carotene with rapeseed lecithin,
beta-carotene with sucrose monopalmitate,
fish oil glycerides with quillaja emulsifier (saponin),
fish oil glycerides with potato protein isolate,
fish oil glycerides with rapeseed lecithin,
fish oil glycerides with sucrose monopalmitate,
conjugated linoleic acid with quillaja emulsifier (saponin),
conjugated linoleic acid with potato protein isolate,
conjugated linoleic acid with rapeseed lecithin,
conjugated linoleic acid with sucrose monopalmitate,
phytosterol esters with quillaja emulsifier (saponin),
phytosterol esters with potato protein isolate,
phytosterol esters with rapeseed lecithin,
phytosterol esters with sucrose monopalmitate.

In a variant of the instant invention one or more of the specific combinations above can be combined/mixed.

That is a variant of the instant invention are stable aqueous clear, transparent dispersions of oil-soluble bioactive compounds and at least one emulsifier, characterised in that they are not microemulsions, the particles containing the bioactive compound have particle sizes of from 20-180 nm or 20-100 nm, the dispersions have an NTU-value of 1-180 at concentrations of 100 ppm of bioactive material and/or the dispersions have an NTU-value of 0.01-30 at concentrations of 5 ppm of bioactive material, wherein the bioactive material and the emulsifier are selected from the combinations of beta-carotene with quillaja emulsifier (saponin), beta-carotene with potato protein isolate, beta-carotene with rapeseed lecithin, beta-carotene with sucrose monopalmitate, fish oil glycerides with quillaja emulsifier (saponin), fish oil glycerides with potato protein isolate, fish oil glycerides with rapeseed lecithin, fish oil glycerides with sucrose monopalmitate, conjugated linoleic acid with quillaja emulsifier (saponin), conjugated linoleic acid with potato protein isolate, conjugated linoleic acid with rapeseed lecithin, conjugated linoleic acid with sucrose monopalmitate, phytosterol esters with quillaja emulsifier (saponin), phytosterol esters with potato protein isolate, phytosterol esters with rapeseed lecithin, phytosterol esters with sucrose monopalmitate and mixtures thereof.

Particularly, well suited commercial products are: Omevital™ 1812 TG Gold (fish oil glycerides) from BASF, Tonalin® TG 80 (conjugated linoleic acid) from BASF, Vegapure® 95 E (phytosterol esters) from BASF, Q-Naturale® 200 (quillaja emulsifier (saponin)) from Ingredion, Solanic® 306 P (potato protein isolate) from Solanic, Lecitin RAP 200 (rapeseed lecithin) from Lecico and Habo Monoester (sucrose monopalmitate).

In one embodiment of the invention the aqueous dispersion containing 5 ppm has a turbidity value of from 0-30 NTU, preferably from 0-25 NTU, more preferably from 0-20 NTU or especially from 0.2-15 NTU.

In a further embodiment of the invention the aqueous dispersion containing 5 ppm bioactive material has a turbidity value selected from the group consisting of: 0.32, 0.37, 0.473, 0.49, 0.544, 0.61, 0.76, 0.903, 1.01, 1.06, 1.11, 1.13, 1.36, 2.57, 3.15, 3.19, 4.53, 4.84, 6, 7.12, 9.96, 10.7, 11.3 and 14.6 NTU.

In one embodiment of the invention the aqueous dispersion containing 100 ppm has a turbidity value of from 1-180 NTU, preferably from 2-180 NTU, more preferably from 4-180 NTU.

In a further embodiment of the invention the aqueous dispersion containing 100 ppm bioactive material has a turbidity value selected from the group consisting of: 4.47, 4.98, 5.71, 6.31, 7.03, 10.2, 13.6, 13.8, 14.7, 16.3, 17.8, 18.4, 18.5, 33.6, 40.2, 42.4, 60, 61, 80.5, 84.3, 127, 134, 142 and 179 NTU.

In a preferred embodiment of the instant invention, only natural or nature-identical, preferably natural, components are used, particularly those that are “GRAS” (generally recognised as safe) and/or those that are of food grade. Additionally, in one embodiment the organic solvent used is, if necessary, reduced to below a level that is required by applicable regulations like e.g. FDA.

In one embodiment of the instant invention, the emulsifiers is not a monosaccharide ester.

In one embodiment of the instant invention the entire process is done at pressure of up to 2500 bar, preferably up to 100 bar, more preferably, up to 10 bar and even more preferably up to 5 bar.

In one embodiment of the instant invention the entire process is done at pressure of between 0.2 and 5 bar (absolute).

In one embodiment of the instant invention the entire process is done at ambient or atmospheric pressure.

In one embodiment the preparation of the organic phase by dissolving of the bioactive material, especially a carotenoid, with the water miscible organic solvent is done at temperatures between −20 and 50° C., in another embodiment between 0 and 40° C., and in yet another embodiment between 10 and 30° C.

In one embodiment of the instant invention the process steps are done at atmospheric pressure and between 10 and 30° C.

In one embodiment of the instant invention the bioactive material is not present in colloidally disperse form.

In one embodiment of the instant invention the emulsifier is left out and the process otherwise done the same.

In one embodiment of the instant invention the emulsifier is not a swellable colloid.

The various embodiments of the instant invention, including those of the dependent claims, can be combined with each other in any desired manner.

The invention will now be explained by way of the following non-limiting examples.

### EXAMPLES

In the examples the following materials were used:
Delios (medium chain triglyceride oil (MCT)) (obtained from BASF)

As bioactive substances (all obtained from BASF):
beta-Carotene,
Omevital 1812 TG Gold (fish oil)
Tonalin TG 80 (conjugated linoleic acid)
Vegapure 95 E (phytosterole)

As emulsifiers:
(1) Q-Naturale 200 (quillaja emulsifier (saponin)) (obtained from Ingredion, Westchester, Ill., USA)
(2) Solanic 306 P (potato protein isolate) (obtained from Solanic (Veendam Netherlands)
(3) Lecithin RAP 200 (Rapeseed lecithin) (obtained from Lecico (Hamburg, Germany)
(4) Habo Monoester P 90 (sucrose monopalmitate) (obtained from Compass Foods)

The color intensity value of aqueous solutions (E 1/1) is defined as the absorbance of light at maximum absorbance (different for each bioactive) going through 1 cm cuvette containing 1% bioactive dispersion. If the color intensity value (E 1/1) is measured at lower concentration than 1%, the measured value of the color intensity has to be corrected with a dilution factor.

E1/1=(Aₘₐₓ×20)/(weight of sample (g))

In the examples the following procedures were followed each time:

An organic phase was made by dissolving 0.2% of the respective bioactive material and 0.02% dl-alpha-tocopherol in tetrahydrofurane (batch of 100 g organic phase was used).

A water phase was made by dissolving 0.1% of the respective emulsifier in distilled water, and 0.02% sodium ascorbate (batch of 1900 g water phase was used).

The two fluids (water phase and organic phase) were combined by colliding a jet of each fluid in a T-intersection pipe with small diameter (0.1 mm) at high velocity (900 m/s for the water phase and 50 m/s for the organic phase).

When the two jets met, a highly turbulent flow was created followed by aggregation of the bioactive when the THF started mixing with the water phase.

The fluids were combined in such a way that the final mixture contained 100 ppm of the respective bioactive material, 50 ppm of the respective emulsifier, 10 ppm dl-alpha-tocopherol, 200 ppm sodium ascorbate, and 5% THF.

### Examples 1 to 12

In each of the examples 1 to 12 beta-carotene was always used as the bioactive material.

A variety of emulsifiers were tested, three of which are given bellow as representative examples of the respective types of emulsifier.

Furthermore beta-carotene was tested both with and without oil present representing both beta-carotene particles (without oil) and beta-carotene emulsions (in MCT oil). Finally the tests were done with and without heating so that beta-carotene with both high and low trans-content was tested (Table 1).

TABLE 1
Recipe and results of experiments containing beta-carotene

| | | | | | | | | Turbidity | Turbidity | |
|---|---|---|---|---|---|---|---|---|---|---|
| | | | | DI-alfa | | | | (NTU) | (NTU) | |
| | | | | toco- | | | Particle | 100 ppm | 5 ppm | |
| | active | | Oil | pherol | emulsi- | | diameter | β- | β- | |
| Nr. | 100 ppm | heating | 50 ppm | 10 ppm | fier | pH | [nm] | carotene | carotene | E1/1 |
| 1 | β-carotene | no | no | yes | 1 | 5.3 | 84 | 84.3 | 7.12 | 190 |
| 2 | β-carotene | no | no | yes | 2 | 2.1 | 76 | 127 | 10.7 | 182 |
| 3 | β-carotene | no | no | yes | 3 | 9 | 122 | 61 | 4.84 | 190 |
| 4 | β-carotene | 90° C., | no | yes | 1 | 5.3 | 93 | 42.4 | 3.15 | 151 |
| | | 30 min | | | | | | | | |
| 5 | β-carotene | 90° C., | no | yes | 2 | 2.1 | 104 | 60 | 4.53 | 132 |
| | | 30 min | | | | | | | | |
| 6 | β-carotene | 90° C., | no | yes | 3 | 9 | 87 | 18.4 | 1.36 | 148 |
| | | 30 min | | | | | | | | |
| 7 | β-carotene | no | MCT oil | yes | 1 | 5.3 | 119 | 142 | 11.3 | 191 |
| 8 | β-carotene | no | MCT oil | yes | 2 | 1.8 | 139 | 179 | 14.6 | 159 |
| 9 | β-carotene | no | MCT oil | yes | 3 | 9 | 130 | 40.2 | 3.19 | 180 |
| 10 | β-carotene | 90° C., | MCT oil | yes | 1 | 5.3 | 121 | 80.5 | 6 | 166 |
| | | 30 min | | | | | | | | |
| 11 | β-carotene | 90° C., | MCT oil | yes | 2 | 1.8 | 131 | 134 | 9.96 | 140 |
| | | 30 min | | | | | | | | |
| 12 | β-carotene | 90° C., | MCT oil | yes | 3 | 9 | 91 | 33.6 | 2.57 | 157 |
| | | 30 min | | | | | | | | |

The results show that by using this process of the instant invention it was possible to make small particles with very low turbidity (Table 1). All experiments showed turbidity below 20 NTU if 5 ppm solutions where made.

Most clear dispersions have turbidity around 10-30, and the results of the instant invention are substantially below that level. For instance, example 6 has 100 ppm turbidity below 20 NTU and therefore the 100 ppm solution has a clear appearance.

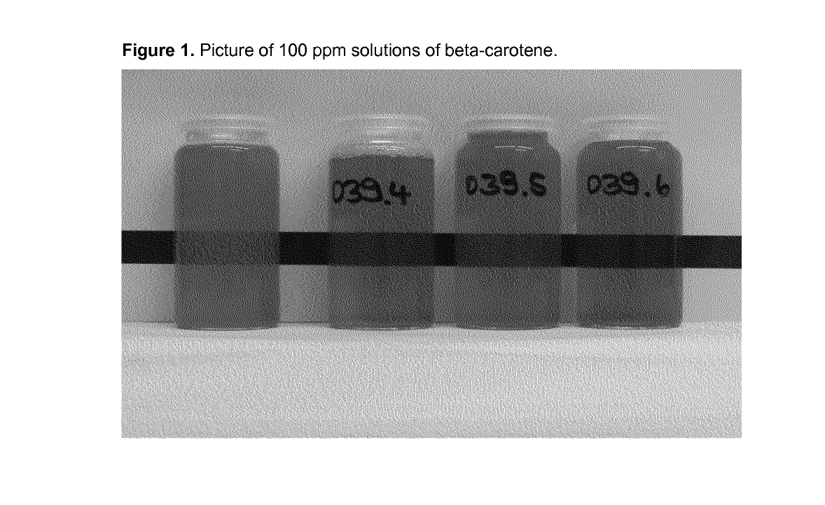

As colour photographs generally do not reproduce in sufficient quality in patent documents they are only presented in this priority application as FIG. 1, which will become available to the public via electronic file inspection as electronic copy once the application claiming the priority of this application will be published. This FIG. 1 for example shows that the solution of example 6 (denoted “039.6”) indeed has a clear appearance.

The results show that all the selected emulsifier types can be used to make clear dispersions and clear dispersions can be made with and without added oil and with and without heating.

Surprisingly, rapeseed lecithin always resulted in the clearest solutions, which is interesting since lecithin is generally not considered a very good emulsifier.

### Examples 13 to 24

In further experiments clear dispersions of fish oil, conjugated linoleic acid (CLA) and phytosterols were made.

The results show that the dispersions are very clear, even clearer than the beta-carotene dispersions. All 100 ppm dispersions had turbidity below 15 NTU and some even below 5 NTU.

This was the first time that such clear dispersions have been made without making microemulsions.

Further, this was also the first time that a clear dispersion stabilised by protein was made.

TABLE 2
Recipe and results of experiments containing fish oil, CLA or phytosterole.

| | | | DI-alfa- | | | | Turbidity | Turbidity |
|---|---|---|---|---|---|---|---|---|
| | Active | | toco- | Emulsi- | | Particle | (NTU) | (NTU) |
| | commercial | Active | pherol | fier | | diameter | 100 ppm | 5 ppm |
| Nr. | name | 100 ppm | 10 ppm | 50 ppm | pH | [nm] | active | active |
| 13 | Omevital 1812 | Fish oil | yes | 1 | 4.5 | 82 | 13.6 | 0.76 |
| | TG gold | | | | | | | |
| 14 | Omevital 1812 | Fish oil | yes | 2 | 2 | 93 | 17.8 | 1.01 |
| | TG gold | | | | | | | |
| 15 | Omevital 1812 | Fish oil | yes | 3 | 4.3 | 63 | 5.71 | 0.37 |
| | TG gold | | | | | | | |
| 16 | Omevital 1812 | Fish oil | yes | 4 | 4.2 | 73 | 6.31 | 0.473 |
| | TG gold | | | | | | | |
| 17 | Tonalin TG 80 | Conjugated | yes | 1 | 4.3 | 80 | 14.7 | 0.903 |
| | | linoleic acid | | | | | | |
| 18 | Tonalin TG 80 | Conjugated | yes | 2 | 2.1 | 92 | 18.5 | 1.06 |
| | | linoleic acid | | | | | | |
| 19 | Tonalin TG 80 | Conjugated | yes | 3 | 4 | 149 | 16.3 | 1.11 |
| | | linoleic acid | | | | | | |
| 20 | Tonalin TG 80 | Conjugated | yes | 4 | 4.2 | 119 | 7.03 | 0.544 |
| | | linoleic acid | | | | | | |
| 21 | Vegapure 95 E | phytosterole | yes | 1 | 5 | 68 | 10.2 | 0.61 |
| 22 | Vegapure 95 E | phytosterole | yes | 2 | 2 | 82 | 13.8 | 1.13 |
| 23 | Vegapure 95 E | phytosterole | yes | 3 | 4.8 | 51 | 4.47 | 0.32 |
| 24 | Vegapure 95 E | phytosterole | yes | 4 | 4 | 70 | 4.98 | 0.49 |

Accordingly, it was shown that stable small and clear dispersions could and were made with various bioactive compounds using various emulsifiers by employing the specific process parameters of the instant invention.

1.-11. (canceled)

12. A stable aqueous clear, transparent dispersions of oil-soluble bioactive compound and at least one emulsifier,
wherein
they are not microemulsions,
the particles containing the bioactive compound have particle sizes of from 20-180 nm or 20-100 nm,
the dispersions have an NTU-value of 1-180 at concentrations of 100 ppm of bioactive material and/or
the dispersions have an NTU-value of 0.01-30 at concentrations of 5 ppm of bioactive material.

13. The dispersions according to claim 12, wherein the bioactive compound is selected from the group consisting of omega-3 fatty acids, carotenoids, vitamin-A, vitamin-D, phytosterols, CLA, animal oils and mixtures thereof.

14. The dispersions according to claim 12, wherein
(i) the bioactive is selected from the group consisting of carotenoid, particularly beta-carotene, animal oil, particularly fish oil, PUFA, particularly CLA and phytosterols and
(ii) the emulsifier is selected from the group selected from saponin, surface active protein, preferably selected from the group consisting of gelatine, whey protein, whey protein isolate, sodium caseinate and other milk proteins, soy protein, potato protein, potato protein isolate and mixtures thereof, phospholipides, preferably those with plant derived fatty acid residues, monosaccharide monoesters of fatty acids, preferabyl sucrose monopalmitate and mixtures thereof.

15. The dispersions according to claim 12, wherein the disperisons are prepared by
a) preparing an organic phase by dissolving at least one bioactive material and optionally at least one antioxidant in an organic solvent that is water miscible,
b) preparing a water phase by dissolving at least one emulsifier and optionally at least one antioxidant in distilled water,
c) combining the organic phase and the water phase in a ratio of from 1:10 to 1:30, by a means to create highly turbulent flow,
d) recovering the resulting dispersion, and
e) optionally removing the organic solvent from the dispersion.

16. The dispersions according to claim 12, wherein the disperisons are prepared by
a) preparing an organic phase by dissolving at least one bioactive material and optionally at least one antioxidant in tetrahydrofurane,
b) preparing a water phase by dissolving at least one emulsifier and optionally at least one antioxidant in distilled water,
c) combining the organic phase and the water phase in a ratio of from 1:17 to 1:23, by colliding a jet of each fluid in a T-intersection pipe with small diameter, between 0.02 to 1.0 mm, at high velocity, between 700 and 1100 m/s for the water phase and between 25 and 75 m/s for the organic phase,
d) recovering the resulting dispersion, and
e) optionally removing the organic solvent from the dispersion.

17. The dispersions according to claim 12, wherein the disperisons are prepared by
a) preparing an organic phase by dissolving at least one bioactive material and optionally at least one antioxidant in tetrahydrofurane,
b) preparing a water phase by dissolving at least one emulsifier and optionally at least one antioxidant in distilled water,
c) combining the organic phase and the water phase in a ratio of from 1:17 to 1:23, by colliding a jet of each fluid in a T-intersection pipe with small diameter, 0.1 mm at high velocity, at high velocity 900 m/s for the water phase and 50 m/s for the organic phase,
d) recovering the resulting dispersion, and
e) optionally removing the organic solvent from the dispersion.

18. The dispersions according to claim 12, wherein the bioactive when being a carotenoid is employed together with an isomerisation aid.

19. The dispersions according to claim 12, wherein the bioactive when being a carotenoid is employed together with a MCT oil.

20. A process for preparing stable, clear, transparent dispersions, of claim 12, or particles wherein the process comprises the steps of
a) preparing of an organic phase by dissolving at least one bioactive material and optionally at least one antioxidant in an organic solvent that is water miscible, most preferably tetrahydrofurane,
b) preparing a water phase by dissolving at least one emulsifier and optionally at least one antioxidant in distilled water,
c) combining the organic phase and the water phase in a ratio of from 1:10 to 1:30, by a means to create highly turbulent flow,
d) recovering the resulting dispersion, and
e) optionally removing the organic solvent from the dispersion.

21. A process for preparing stable, clear, transparent dispersions, of claim 12, or particles wherein the process comprises the steps of
a) preparing of an organic phase by dissolving at least one bioactive material and optionally at least one antioxidant in tetrahydrofurane,
b) preparing a water phase by dissolving at least one emulsifier and optionally at least one antioxidant in distilled water,
c) combining the organic phase and the water phase in a ratio of from from 1:15 to 1:25, by a means to create highly turbulent flow, preferably by colliding a jet of each fluid in a T-intersection pipe with small diameter (0.1 mm) at high velocity (900 m/s for the water phase and 50 m/s for the organic phase),
d) recovering the resulting dispersion, and)
e) optionally removing the organic solvent from the dispersion.

22. A process for preparing stable, clear, transparent dispersions, of claim 12, or particles wherein the process comprises the steps of
a) preparing of an organic phase by dissolving at least one bioactive material and optionally at least one antioxidant in tetrahydrofurane,
b) preparing a water phase by dissolving at least one emulsifier and optionally at least one antioxidant in distilled water,
c) combining the organic phase and the water phase in a ratio of from 1:17 to 1:23, by a means to create highly turbulent flow, preferably by colliding a jet of each fluid in a T-intersection pipe with small diameter (0.1 mm) at high velocity (900 m/s for the water phase and 50 m/s for the organic phase),
d) recovering the resulting dispersion, and
e) optionally removing the organic solvent from the dispersion.

23. The process according to claim 20, wherein the fluids in step c) are combined in such a way that the final mixture contains 1 and 1000 ppm of the respective bioactive material, between 1 and 1000 ppm, of the respective emulsifier, 10 ppm dl-alpha-tocopherol, 200 ppm sodium ascorbate, and 5% of the organic solvent.

24. The process according to claim 20, wherein the fluids in step c) are combined in such a way that the final mixture contains between 50 and 200 ppm of the respective bioactive material, between 25 and 100 ppm of the respective emulsifier, 10 ppm dl-alpha-tocopherol, 200 ppm sodium ascorbate, and 5% of the organic solvent.

25. The process according to claim 20, wherein the fluids in step c) are combined in such a way that the final mixture contains 100 ppm of the respective bioactive material, 50 ppm of the respective emulsifier, 10 ppm dl-alpha-tocopherol, 200 ppm sodium ascorbate, and 5% of the organic solvent.

26. The process according to claim 20, wherein the dispersions are dried, resulting in dry powder with water content below 10% by weight, to give the particles.

27. The process according to claim 207, wherein the dispersions are spray dried resulting in dry powder with water content below 5% by weight, to give the particles.

28. A beverage comprising the dispersions according to claim 12.

29. Preparations comprising the dispersion according to claim 12.

30. Solid particles prepared by the process of claim 20.
